(19) United States
(12) Patent Application Publication
(10) Pub. No.: US 2002/0043124 A1
(43) Pub. Date: Apr. 18, 2002

(54) Plastic gear and method of producing the same

(75) Inventors: Hirotaka Shiga, Yokohama (JP); Atsushi Tsuboi, Kanagawa (JP); Yuzuru Morioka, Kanagawa (JP)

Correspondence Address: Richard L. Schwaab, FOLEY & LARDNER, Washington Harbour, 3000 K Street, N.W., Suite 500, Washington, DC, 20007-5109, US

(73) Assignee: UNISIA JECS CORPORATION

(21) Appl. No.: 09/833,669

(22) Filed: Apr. 13, 2001

(30) Foreign Application Priority Data
Apr. 20, 2000 (JP) 2000-119635

(51) Int. Cl. F16H 55/12

(52) U.S. Cl. 74/434; 74/439; 264/DIG. 10

(57) ABSTRACT

A plastic gear is provided which includes a main body portion and a toothed portion. The main body portion is made of a synthetic resin containing reinforcement fibers. The toothed portion is made of a synthetic resin which is the same as the synthetic resin of which the main body portion is made except that it does not contain any reinforcement fibers. A method of producing such a plastic gear is also provided.

### BACKGROUND OF THE INVENTION

The present invention relates to a plastic gear which is suited for adoption to various power transmitting gears such as a worm wheel of a vehicle steering system. The present invention further relates to a method of producing such a plastic gear.

A gear for transmitting power is required to have a predetermined mechanical strength and suppress production of a noise due to engagement of gear teeth as much as possible.

Thus, it is proposed, as disclosed in Japanese Patent Provisional Publication No. 1-250668, a plastic gear consisting of a main body portion and a toothed portion formed with a plurality of gear teeth. The main body portion is formed of a hard plastic material and the toothed portion is formed of a soft plastic material.

The above described plastic gear can have a desired mechanical strength since the main body portion is made of a hard plastic material and also can suppress production of a noise since the toothed portion is formed of a soft plastic material.

### SUMMARY OF THE INVENTION

However, the prior art plastic gear has such a problem that since the main body portion is made of a hard synthetic resin and the toothed portion is made of a soft synthetic resin, i.e., both are made of different materials, there is a possibility that the joining condition of both tends to lack the stability and reliability. For this reason, it is necessitated to provide a mechanical fixing means such as projections and depressions at the joint between the main body portion and the toothed portion. This leads to a possibility of increasing the manufacturing cost.

It is accordingly an object of the present invention to provide a plastic gear which can be manufactured at low cost.

It is a further object of the present invention to provide a method of producing a gear of the foregoing character.

To accomplish the above objects, there is provided according to an aspect of the present invention a plastic gear comprising a main body portion made of a first synthetic resin, and a toothed portion having a plurality of teeth and made of a second synthetic resin, the first synthetic resin and the second synthetic resin corresponding in composition to each other except that the first synthetic resin further contains reinforcement fibers.

According to another aspect of the present invention, there is provided a method of producing a plastic gear having a main body portion and a toothed portion having a plurality of teeth, comprising a main body portion forming step of forming the main body portion from a first synthetic resin by injection molding, and a toothed portion forming step of forming the toothed portion from a second synthetic resin by injection molding, wherein the first synthetic resin and the second synthetic resin correspond in composition to each other except that the first synthetic resin further contains reinforcement fibers, and wherein the injection molding of one of the main body forming step and the toothed portion forming step is executed after disposing in a mold one of the main body portion and the toothed portion which is obtained by the other of the main body portion forming step and the toothed portion forming step.

The other objects and features of this invention will become understood from the following description with reference to the accompanying drawings.

### BRIEF DESCRIPTION OF THE DRAWINGS

FIG. 1 a sectional view of a plastic gear according to an embodiment of the present invention;

FIG. 2 is a sectional view taken along the line II-II of FIG. 1;

FIG. 3 is an enlarged view of an important portion of FIG. 1;

FIG. 4 is a view for illustrating a step for forming a main body portion of the gear of FIG. 1;

FIG. 5 is a sectional view of the main body portion produced by the step of FIG. 4;

FIG. 6 is a view for illustrating a step of disposing the main body portion of FIG. 5 within a mold and forming a toothed portion by injection molding;

FIG. 7 is a view similar to FIG. 1 but shows another embodiment;

FIG. 8 is a sectional view taken along the line VIII-VIII of FIG. 7;

FIG. 9 is a view similar to FIG. 1 but shows a further embodiment;

FIG. 10 is a view taken along the line X-X of FIG. 9;

FIG. 11 is an enlarged view of an important portion of FIG. 9;

FIG. 12 is a view similar to FIG. 1 but shows a further embodiment;

FIG. 13 is a sectional view taken along the line XIII-XIII of FIG. 12; and

FIG. 14 is an enlarged view of an important portion of FIG. 12.

### DESCRIPTION OF THE PREFERRRED EMBODIMENTS

Referring to the drawings, a plastic gear is generally indicated by 1 and made up of a main body portion 2 and a toothed portion 4 formed with a plurality of teeth 3. In this embodiment, the gear 1 is shown by way of example as an externally toothed gear.

The main body portion 2 is made of a synthetic resin such as polyamide, polyacetal, saturated polyester, polyether and etherketon. The synthetic resin contains reinforcement fibers such as metal fibers, carbon fibers and glass fibers. The main body portion 2 has tooth core sections 5 each of which is extended into the inside of each tooth 3. Each tooth core section 5 has a radially outer end which is rounded or curved and an axial length W2 which is smaller than the axial length WI of the plastic wheel 1.

On the axially opposite sides of the main body portion 2 are formed a pair of circumferential annular grooves 6. Further, on the inner circumferential side of the main body portion 2 is disposed a ring 7 which is made of steel such as S45C (carbon steel according to Japanese Industrial Standard).

The toothed portion 4 is made of a synthetic resin which is the same as the synthetic resin of which the main body portion 2 is made except that it does not contain any reinforcement fibers. Namely, the synthetic resin of which the main body portion 2 is made and the synthetic resin of which the toothed portion 4 is made differ only in that the synthetic resin of which the main body portion 2 is made further contains the reinforcement fibers, or the synthetic resin of which the main body portion 2 is made and the synthetic resin of which the toothed portion 4 is made correspond in composition to each other except that the synthetic resin of which the main body portion 2 is made further contains reinforcement fibers

The plastic gear 1 is produced in the following manner.

Firstly, either of the main body portion 2 or toothed portion 4, i.e., the main body portion 2 in this embodiment is first formed by injection molding. Specifically, as shown in FIG. 4, under the condition where the ring 7 is disposed within a mold 10, a synthetic resin containing reinforcement fibers is injected into the mold 10 by way of a nozzle 11 and runner 12 (main body portion forming step). In this instance, the synthetic resin containing reinforcement fibers and constituting the main body portion 2 is injected so as to cause the reinforcement fibers to extend from a radially inner side to a radially outer side of the main body portion 2.

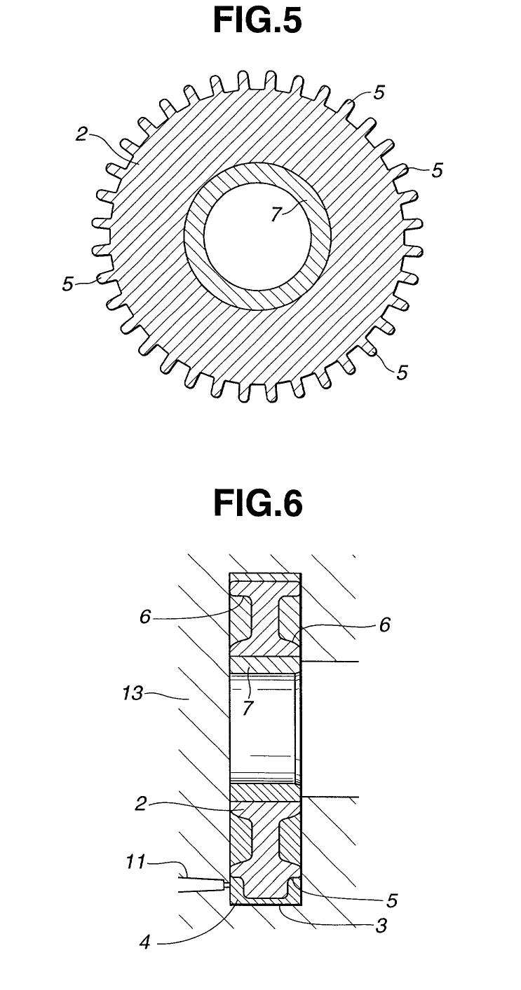

By this, the main body portion 2 as shown in FIG. 5 is obtained. In the meantime, portions such as the nozzle 11 and runner 12 formed at the time of injection molding of the main body portion 2 are cut off after the molding.

Then, as shown in FIG. 6, the toothed portion 4 is formed by injection molding, with the main body portion 2 being disposed in a mold 13 (toothed portion forming step). The toothed portion 4 is made of a synthetic resin which is the same as the synthetic resin of which the main body portion 2 is made except that it does not contain any reinforcement fibers. In the meantime, in this embodiment, the synthetic resin constituting the toothed portion 4 is also introduced into the annular grooves 6 formed in the main body portion 2 to fill up the same.

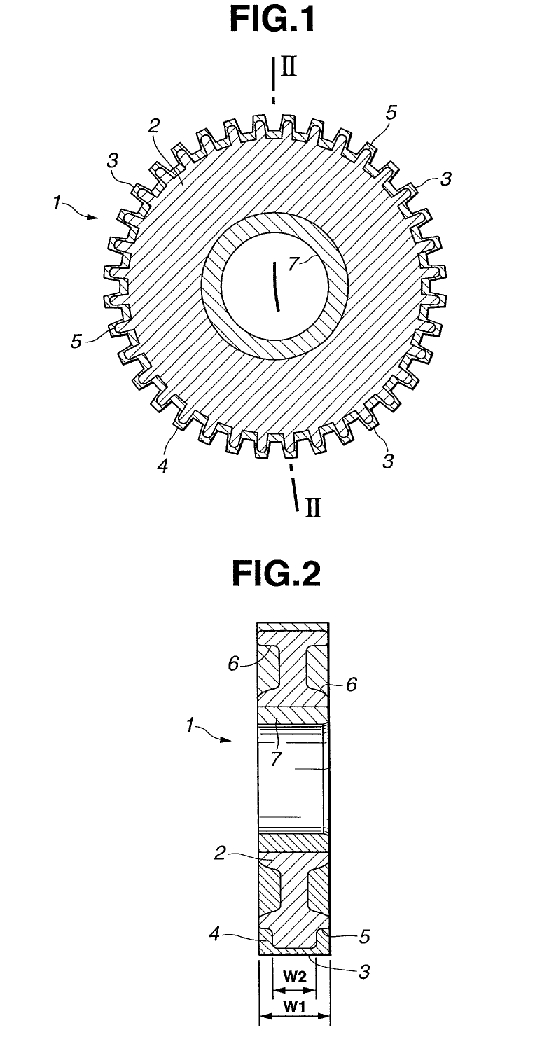

By this, the plastic gear 1 as shown in FIG. 1 is obtained.

The plastic gear 1 produced by the above described main body portion forming step and toothed portion forming step is made of generally or substantially the same synthetic resin, and the main body portion contains reinforcement fibers but the toothed portion 4 does not.

For this reason, the above described plastic gear 1 can attain a desired mechanical strength since the main body portion 2 is formed from a synthetic resin containing reinforcement fibers and can prevent or suppress production of a noise since the toothed potion 4 is formed from a synthetic resin not containing reinforcement fibers. Further, the main body portion 2 and the toothed portion 4 are made of generally or substantially the same synthetic resin such that both are connected or combined firmly. As a result, it becomes unnecessary to provide a mechanical fixing means between the main body portion 2 and the toothed portion 4.

Accordingly, the plastic gear 1 can be manufactured at low cost by the above described method.

Further, since the toothed portion 4 has the tooth core section 5 extended into the inside of each tooth 3, the mechanical strength of each tooth 3 can be increased by the tooth core section 5.

Further, since each tooth core section 5 has a radially outer end which is rounded or curved, it does not have any angled or edgy portion, thus making it possible to effectively prevent stress concentration at the joint between the tooth core section 5 of the main body portion 2 and the toothed portion 4.

Further, since the main body portion forming step for molding the main body portion 2 is performed prior to the toothed portion forming step for molding the toothed portion 4, the main body portion 2 which occupies most of the volume of the plastic wheel 1 is first formed of a synthetic resin containing reinforcement fibers by molding. After contraction and solidification of the main body portion 2, the toothed portion 4 is formed by injection molding with the main body portion 2 being disposed in the mold 13. Since the main body portion 2 is made of a synthetic resin containing reinforcement fibers, its contraction can be small. After injection molding of the toothed portion 4, the dimensional accuracy of the plastic gear 1 is determined depending upon contraction of the toothed portion 4 only, thus making it possible to obtain the plastic gear 1 having a high dimensional accuracy.

Further, in the main body portion forming step, injection is performed so as to cause the reinforcement fibers to extend from a radially inner side to a radially outer side of the main body portion 2. By this, it becomes possible to suppress radial contraction of the main body portion 2 for thereby improving the dimensional accuracy and furthermore make uniform the mechanical strength.

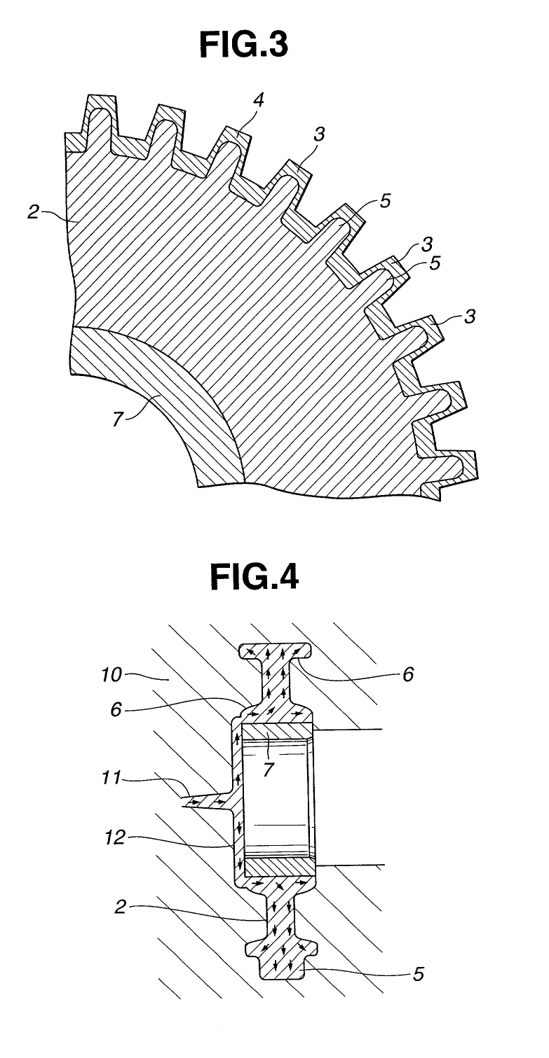

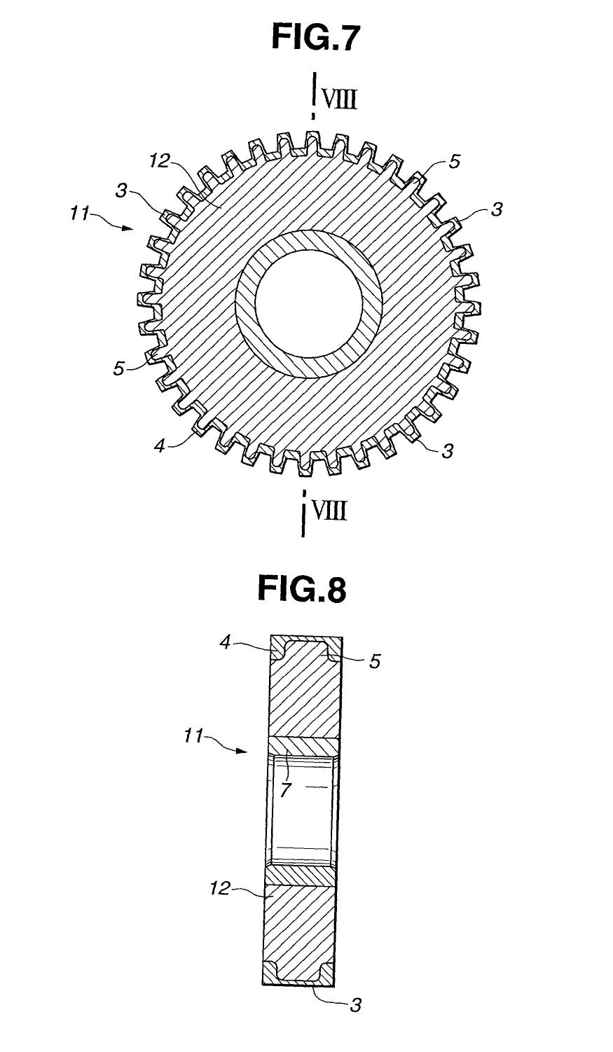

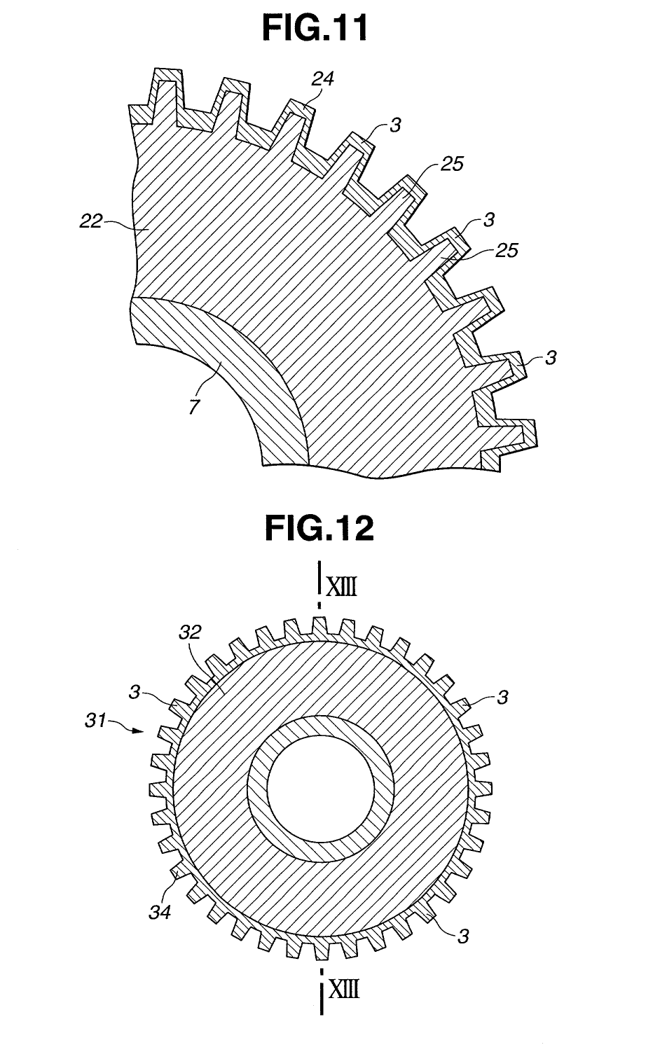

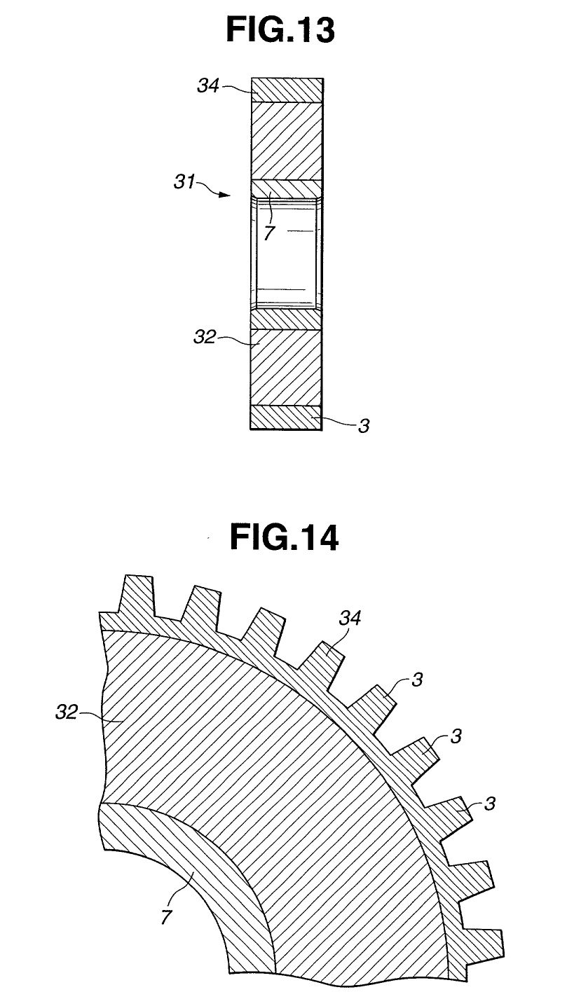

FIGS. 7 to 14 shows further embodiments of the present invention. In FIGS. 7 to 14, like or corresponding portions to those of the previous embodiment described with reference to FIGS. 1 to 6 are designated by like reference characters and repeated description thereto are omitted.

In the embodiment of FIGS. 7 and 8, the main body portion 12 of the plastic gear 11 does not have on the opposite sides thereof such annular groove 6 as in the previous embodiment of FIGS. 1 to 6.

This embodiment enables the main body portion 2 to be partially increased in thickness and have an improved mechanical strength. Except for the above, this embodiment is substantially similar to the previous embodiment and can produce substantially the same effect.

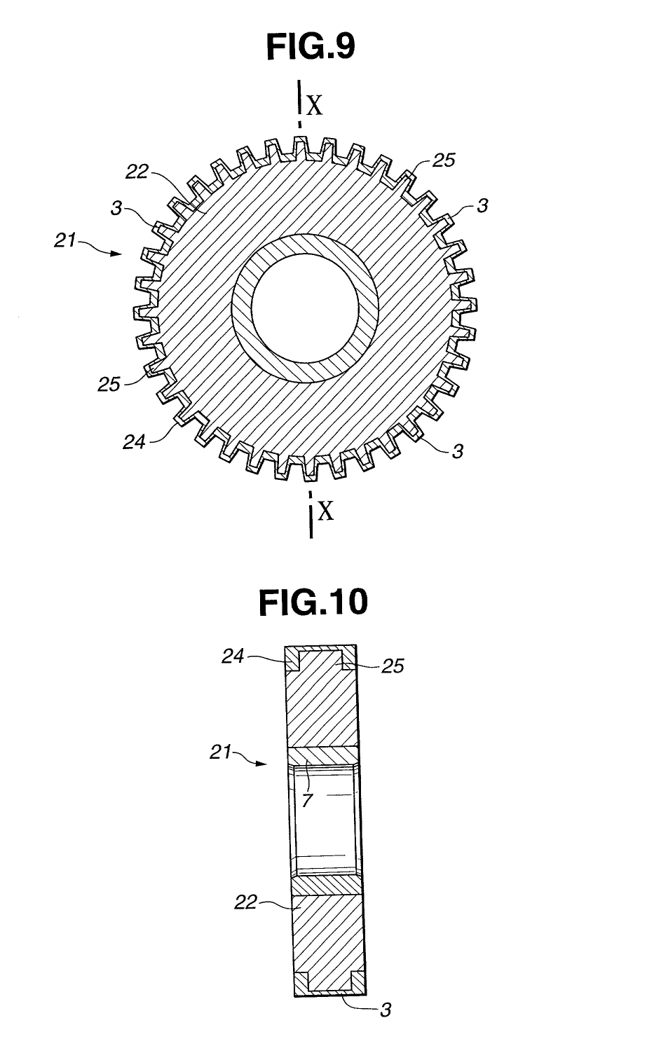

In the embodiment of FIGS. 9 to 11, the plastic gear 21 is modified in addition to a modification of FIGS. 7 and 8 as follows. Namely, the radially outer end of each of the tooth core sections 25 of the main body portion 22 is not rounded but is nearly flat. The toothed portion 24 is shaped corresponding to the modification of the tooth core sections 25.

This embodiment makes it possible to increase the surface area of the outer surface of each tooth core section 25 and thereby make higher the joining strength between the tooth core section 25 and the toothed portion 24. Except for the above, this embodiment is substantially similar to the embodiment of FIGS. 7 and 8 and can produce substantially the same effect.

In the embodiment of FIGS. 12 to 14, the plastic gear 31 is modified in addition to a modification of FIGS. 7 and 8 as follows. Namely, the main body portion 32 does not have such a tooth core section 5 or 25 as in the previous embodiments but have a smoothly curved, outer circumferential periphery. The toothed portion 34 has an inner circumferential periphery which is formed corresponding to the outer circumferential periphery of the main body portion 32.

This embodiment makes it possible for the main body portion 2 to be produced with ease. Except for the above, this embodiment is substantially similar to the previous embodiment of FIGS. 7 and 8 and can produce substantially the same effect.

From the foregoing, it will be understood that the present invention enables to obtain a plastic gear whose manufacturing cost is low and a method of producing the same.

The entire contents of Japanese Patent Application No. P2000-119635, filed Apr. 20, 2000, are incorporated herein by reference.

Although the invention has been described above by reference to certain embodiments of the invention, the invention is not limited to the embodiments described above. Modifications and variations of the embodiments described above will occur to those skilled in the art, in light of the above teachings. For example, the plastic gear can be an internally threaded gear. Further, the threaded portion may be molded first and then the main body portion may be molded with the threaded portion being disposed in a mold. The scope of the invention is defined with reference to the following claims.

What is claimed is:

1. A plastic gear comprising:
a main body portion made of a first synthetic resin; and
a toothed portion having a plurality of teeth and made of a second synthetic resin;
the first synthetic resin and the second synthetic resin corresponding in composition to each other except that the first synthetic resin further contains reinforcement fibers.

2. A plastic gear according to claim 1, wherein the main body portion comprises tooth core sections each of which is disposed inside of each of the teeth of the toothed portion.

3. A plastic gear according to claim 2, wherein each of the tooth core sections of the toothed portion comprises a radially outer end which is rounded.

4. A plastic gear according to claim 1, wherein the first synthetic resin and the second synthetic resin comprise one selected from the group consisting of polyamide, polyacetal, saturated polyester, polyether and etherketon.

5. A plastic gear according to claim 1, wherein the reinforcement fibers comprise at least one kind of fibers selected from the group consisting of metal fibers, carbon fibers and glass fibers.

6. A method of producing a plastic gear having a main body portion and a toothed portion having a plurality of teeth, comprising:
forming the main body portion from a first synthetic resin by injection molding; and
forming the toothed portion from a second synthetic resin by injection molding;
wherein the first synthetic resin and the second synthetic resin correspond in composition to each other except that the first synthetic resin further contains reinforcement fibers.

7. A method according to claim 6, wherein the first synthetic resin and the second synthetic resin comprise one selected from the group consisting of polyamide, polyacetal, saturated polyester, polyether and etherketon.

8. A method according to claim 6, wherein the reinforcement fibers comprise at least one kind of fibers selected from the group consisting of metal fibers, carbon fibers and glass fibers.

9. A method of producing a plastic gear having a main body portion and a toothed portion having a plurality of teeth, comprising:
a main body portion forming step of forming the main body portion from a first synthetic resin by injection molding; and
a toothed portion forming step of forming the toothed portion from a second synthetic resin by injection molding;
wherein the first synthetic resin and the second synthetic resin correspond in composition to each other except that the first synthetic resin further contains reinforcement fibers; and
wherein the injection molding of one of the main body forming step and the toothed portion forming step is executed after disposing in a mold one of the main body portion and the toothed portion which is obtained by the other of the main body portion forming step and the toothed portion forming step.

10. A method according to claim 9, wherein the main body forming step is executed prior to the toothed portion forming step.

11. A method according to claim 9, wherein the injection molding of the main body forming step is executed so as to cause the reinforcement fibers to extend from a radially inner side to a radially outer side of the main body portion.

12. A method according to claim 9, wherein the first synthetic resin and the second synthetic resin comprise one selected from the group consisting of polyamide, polyacetal, saturated polyester, polyether and etherketon.

13. A method according to claim 9, wherein the reinforcement fibers comprise at least one kind of fibers selected from the group consisting of metal fibers, carbon fibers and glass fibers.
